(19) United States
(12) Patent Application Publication
(10) Pub. No.: US 2015/0221078 A1
(43) Pub. Date: Aug. 6, 2015

(54) CALIBRATION DEVICE, DISPLAY SYSTEM AND CONTROL METHOD THEREOF

(71) Applicant: SAMSUNG ELECTRONICS CO., LTD., Suwon-si (KR)

(72) Inventors: Min-jung KIM, Seoul (KR); Hye-rin CHOI, Suwon-si (KR)

(73) Assignee: SAMSUNG ELECTRONICS CO., LTD., Suwon-si (KR)

(21) Appl. No.: 14/596,317

(22) Filed: Jan. 14, 2015

(30) Foreign Application Priority Data
Feb. 4, 2014 (KR) 10-2014-0012710

(51) Int. Cl. G06T 7/00; H04N 9/04

(52) U.S. Cl. CPC G06T 7/0002; H04N 9/045; G06T 2207/10004; G06T 2207/10024

(57) ABSTRACT

A calibration device, a display system, and methods thereof, are provided in which a plurality of display apparatuses are photographed in order to calibrate the plurality of display apparatuses. The calibration device may include a communicator configured to communicate with at least one display apparatus from among a plurality of display apparatuses of a display system, and a controller configured to control the communicator to transmit a setup value for the display apparatuses to the at least one display apparatus, and transmit, to the at least one display apparatus, a control command for calibrating the plurality of display apparatuses based on an image of the plurality of display apparatuses displaying an image, received from the an image taking device

### CROSS-REFERENCE TO RELATED APPLICATION

This application claims priority from Korean Patent Application No. 10-2014-0012710, filed on Feb. 4, 2014 in the Korean Intellectual Property Office, the entire disclosure of which is incorporated herein by reference.

### BACKGROUND

1. Field

Apparatuses and methods consistent with the exemplary embodiments relate to calibration, and more particularly, to a calibration device, a display system and a control method thereof, in which a plurality of display apparatuses are photographed in order to calibrate characteristics of the plurality of display apparatuses.

2. Description of Related Art

In a related calibration device, a contact calibrator is used to calibrate a plurality of display apparatuses. However, in order to perform the calibration the contact calibrator must be brought into direct contact with each of the plurality of display apparatuses. In a case in which one image is displayed on the plurality of display apparatuses, two or more persons and additional equipment are needed for causing the calibrator to be in contact with the plurality of display apparatuses. Accordingly, because contact and one-to-one adjustment are required, time and service costs taken in the calibration are significant.

In an environment in which the calibrator is not available, a user has to perform the calibration intuitively while viewing the display apparatus. In this case, it is difficult to intuitively do the calibration, the calibration has low precision, and much time is needed to perform the calibration.

### SUMMARY

One or more exemplary embodiments provide a calibration device, a display system and a control method thereof, in which a calibration for an image taking device and a plurality of display apparatuses is set up, and then an image of the plurality of display apparatuses displaying an image may be captured by the image taking device and transmitted to the calibration device, thereby performing the calibration for the plurality of display apparatuses based on a characteristic value about the plurality of display apparatuses included in the captured image.

In an aspect according to an exemplary embodiment, there is provided a calibration device including a communicator configured to communicate with at least one display apparatus from among a plurality of display apparatuses of a display system, and a controller configured to control the communicator to transmit a setup value for the display apparatuses to the at least one display apparatus, and transmit, to the at least one display apparatus, a control command for calibrating the plurality of display apparatuses based on an image of the plurality of display apparatuses displaying an image, received from the an image taking device.

The controller may be configured to, in response to receiving an execution command to calibrate the plurality of display apparatuses, control the communicator to transmit the setup value for the plurality of display apparatuses to the at least one display apparatus and transmit the setup value for the image taking device to the image taking device.

The controller may be configured to set up an area of the received image based on the plurality of display apparatuses, and calculate a characteristic value of the set up area of the image.

The calibration device may further include a user input configured to receive a user command, wherein the controller may be configured to determine the control command to cause the one or more display apparatuses to reach a target value, in response to receiving the target value via the user input.

The controller may be configured to select a reference apparatus for calibration from among the plurality of display apparatuses, and control the communicator to transmit the control command to cause remaining display apparatuses from among the plurality of display apparatuses to reach a characteristic value of the selected reference apparatus.

The controller may be configured to, in response to the communicator receiving a message that the calibration is impossible from a display apparatus from among the plurality of display apparatuses, change at least one of a value of the control command and a reference apparatus for the calibration.

The execution command may include an input for selecting at least one of the plurality of display apparatuses, an input for selecting at least one from among an automatic setup mode, a color temperature setup mode, and a reference apparatus setup mode, and an input for setting up brightness, color temperature, and a reference apparatus with regard to the plurality of display apparatuses.

The setup value for the plurality of display apparatuses may include information about at least one of a brightness, a color temperature, and a reference apparatus with regard to the plurality of display apparatuses.

The setup value for the image taking device may include information about at least one of a white balance and an exposure of the image taking device and correspond to at least one of a brightness, a color temperature, and a reference apparatus with regard to the plurality of display apparatuses.

In an aspect according to another exemplary embodiment, there is provided a method of calibrating a plurality of display apparatuses, the method including transmitting a setup value for a plurality of display apparatuses to at least one display apparatus from among the plurality of display apparatuses, transmitting a setup value for an image taking device to the image taking device, receiving an image of the plurality of display apparatuses displaying an image, from the image taking device, and transmitting, to the at least one display apparatus, a control command for calibrating the plurality of display apparatuses based on the received image.

The method may further include receiving an execution command for calibrating the plurality of display apparatuses, wherein the setup value for the plurality of display apparatuses is transmitted to the at least one display apparatus and the setup value for the image taking device is transmitted to the image taking device, in response to the receiving the execution command.

The receiving the image may include setting up an area of the image based on the plurality of display apparatuses, and calculating a characteristic value of the set up area of the image.

The transmitting the control command may include determining the control command to cause the one or more display apparatuses to reach a target value, in response to receiving the target value from a user.

The method may further include selecting one display apparatus from among the plurality of display apparatuses as a reference apparatus for calibration, and the transmitting may include transmitting the control command to cause the remaining display apparatuses from among the plurality of display apparatuses to reach a characteristic value of the selected reference apparatus.

The transmitting the control command may include, in response to receiving a message that the calibration is impossible from a display apparatus from among the plurality of display apparatuses, changing at least one of a value of the control command and a reference apparatus for the calibration.

The execution command may include an input for selecting either some or all of the plurality of display apparatuses, an input for selecting at least one from among an automatic setup mode, a color temperature setup mode, and a reference apparatus setup mode, and an input for setting up brightness, color temperature, and a reference apparatus with regard to the plurality of display apparatuses.

The setup value for the plurality of display apparatuses may include information about at least one of a brightness, a color temperature, and a reference apparatus with regard to the plurality of display apparatuses.

The setup value for the image taking device may correspond to at least one of a white balance and an exposure of the image taking device, and correspond to at least one of brightness, color temperature, and a reference apparatus with regard to the plurality of display apparatuses.

According to an aspect of another exemplary embodiment, there is provided a display system including a plurality of display apparatuses including a first display apparatus and a second display apparatus, the first display apparatus including a first communicator configured to communicate with the second display apparatus; a first image receiver configured to receive an image; a first image processor configured to process the received image; a first display configured to display the processed image; and a first controller configured to receive a control command for calibration from the second display apparatus and perform the calibration, and the second display apparatus including a second communicator configured to communicate with the first display apparatus; a second image receiver configured to receive the image; a second image processor configured to process the received image; a second display configured to display the processed image; and a second controller configured to receive a setup value for the first display apparatus and the second display apparatus, transmit the received setup value to the first display apparatus, transmit a setup value for an image taking device corresponding to the setup value for the first display apparatus and the second display apparatus to an image taking device, receive an image of the first and second display apparatuses displaying images, from the image taking device, perform the calibration based on the received image, and transmit a control command for the calibration to the first display apparatus.

The second controller may be configured to set up an area of the received image in accordance with the first display apparatus, and calculate a characteristic value of a setup area of the image.

The second display apparatus may further include a user input configured to receive a user's command, and the second controller may be configured to determine the control command to cause the first display apparatus to reach a target value, in response to receiving the target value from a user.

In response to the second display apparatuses being selected as a reference apparatus for calibration, the second controller may be configured to transmit a control command to the first display apparatus to cause the first display apparatus to reach a characteristic value of the second display apparatus.

In response to receiving a message indicating that the calibration is impossible from the first display apparatus, the second controller may be configured to change at least one of a value of the control command for the first display apparatus and a reference apparatus for the calibration.

The setup value for the first and second display apparatuses may include an input for selecting either some or all of the plurality of display apparatuses, an input for selecting at least one from among an automatic setup mode, a color temperature setup mode, and a reference apparatus setup mode, and an input for setting up a brightness, a color temperature, and a reference apparatus with regard to the plurality of display apparatuses.

The setup value for the plurality of display apparatuses may correspond to at least one of a brightness, a color temperature, and a reference apparatus with regard to the plurality of display apparatuses.

The setup value for the image taking device may correspond to at least one of a white balance and an exposure of the image taking device, and correspond to at least one of a brightness, a color temperature, and a reference apparatus with regard to the plurality of display apparatuses.

According to an aspect of another exemplary embodiment, there is provided a method of calibrating a plurality of display apparatuses including a first display apparatus and a second display apparatus, the method including receiving, by the second display apparatus, a setup value for the first display apparatus and the second display apparatus, transmitting, by the second display apparatus, the received setup value to the first display apparatus, transmitting, by the second display apparatus, a setup value for an image taking device corresponding to the setup value for the first display apparatus and the second display apparatus, to the image taking device, receiving, by the second display apparatus, an image captured of the first and second display apparatuses displaying images, from the image taking device, transmitting, by the second display apparatus, a control command for calibration to the first display apparatus based on the received image, receiving, by the first display apparatus, a control command for calibration from the second display apparatus to perform the calibration, and performing, by the second display apparatus, the calibration based on the received image.

The receiving of the image may include setting up an area of the received image in accordance with the first display apparatus, and calculating a characteristic value of a setup area of the image.

The transmitting of the control command to the first display apparatus may include calculating the control command for the first display apparatus to reach a target value, in response to receiving the target value from a user.

The transmitting of the control command to the first display apparatus may include, in response to the second display apparatus being selected as a reference apparatus for calibration, transmitting a control command to cause the first display apparatus to reach a characteristic value of the second display apparatus.

The transmitting of the setup value to the first display apparatus may include, in response to receiving a message indicating that the calibration is impossible from the first display apparatuses, changing at least one of a value of the control command and a reference apparatus for the calibration.

The setup value for the first and second display apparatuses may include an input for selecting either some or all of the plurality of display apparatuses, an input for selecting at least one among an automatic setup mode, a color temperature setup mode, and a reference apparatus setup mode, and an input for setting up a brightness, a color temperature, and a reference apparatus with regard to the plurality of display apparatuses.

The setup value for the first and second display apparatuses may correspond to at least one of a brightness, a color temperature, and a reference apparatus with regard to the plurality of display apparatuses.

According to one or more exemplary embodiments, the image taking device may perform the calibration by calculating the setup value for the calibration of the plurality of display apparatuses, thereby reducing time and costs that occur in the calibration of the plurality of display apparatuses and further improving accuracy of the calibration thereof.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram illustrating a calibration device according to an exemplary embodiment;

FIG. 2 is a block diagram illustrating the calibration device according to another exemplary embodiment;

FIG. 3 is a diagram illustrating a display apparatus that is calibrated by the calibration device according to an exemplary embodiment;

FIG. 4 is a flowchart illustrating a calibration method of the calibration device according to an exemplary embodiment;

FIGS. 5 and 6 are flowcharts illustrating calibration methods of the calibration device according to other exemplary embodiments;

FIG. 7 is a block diagram illustrating a display system according to an exemplary embodiment;

FIG. 8 is a block diagram illustrating a display system according to another exemplary embodiment;

FIG. 9 is a diagram illustrating a display apparatus that is calibrated by the display system according to an exemplary embodiment;

FIG. 10 is a flowchart illustrating a calibration method of a display system according to an exemplary embodiment;

FIGS. 11 and 12 are flowcharts illustrating calibration methods of the display system according to other exemplary embodiments; and

FIGS. 13 to 16 are flowcharts illustrating calibration methods of the display system according to exemplary embodiments.

### DETAILED DESCRIPTION

The exemplary embodiments will be described in detail with reference to accompanying drawings. One or more of the exemplary embodiments may be achieved in various forms and are not limited to the following embodiments. For convenience of description, parts not directly related to the present disclosure are omitted, and like numerals refer to like elements throughout.

According to an exemplary embodiment, a calibration device may calibrate a difference in a characteristic value among a plurality of display apparatuses of a display system displaying an image. If an execution command to calibrate the plurality of display apparatuses is received, the calibration device transmits a setup value about the display apparatuses corresponding to the execution command to the plurality of display apparatuses, and transmits a setup value optimized for taking an image through the image taking device. Then, the calibration device receives the image taken by photographing the plurality of display apparatuses of the display system while the plurality of display apparatuses are displaying an image or other data to be used for calibration based on the setup value, and determines a characteristic value about each image of the display apparatuses. In response, the calibration device sends a control command or a setup value for calibration to the plurality of display apparatuses to cause the respective display apparatuses to have the same characteristic value. For example, the calibration device may instruct one or more of the display apparatuses to adjust or otherwise modify a feature of the respective display apparatus. As referred to herein, the control command may be or may include a setup value for a display.

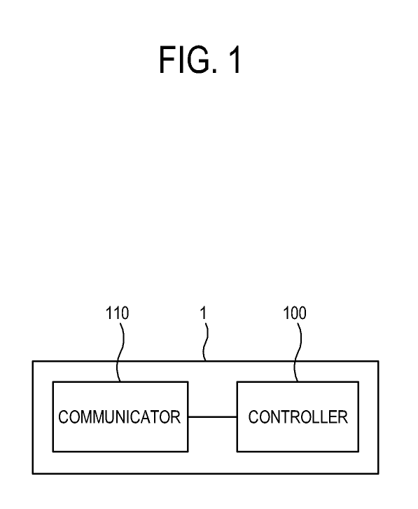

FIG. 1 is a block diagram illustrating a calibration device 1 according to an exemplary embodiment. The calibration device 1 in this example includes a communicator 110 and a controller 100. For example, the calibration device may be a personal computer, a notebook computer, a user terminal, a mobile phone, a tablet, and the like.

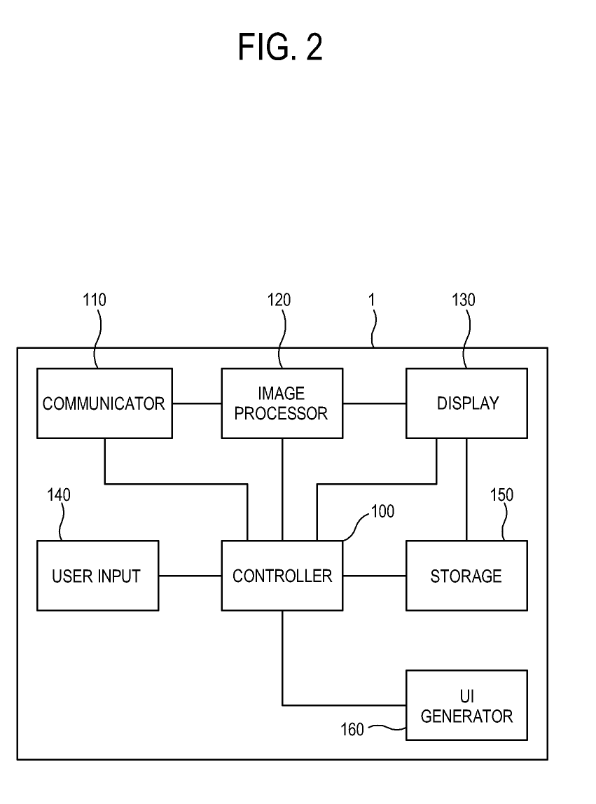

The communicator 110 receives a signal based on an external input and transmits it to the controller 100 or an image processor 120 (shown in FIG. 2). The communicator 110 connects with various external input devices and cables and receives a signal from the corresponding external input through a wire, or wirelessly receives a signal through one or more wireless communication standards.

The communicator 110 may include a plurality of connectors to which cables are respectively connected. The communicator 110 may receive a signal from the connected external inputs, for example, a broadcasting signal, a video signal, a data signal, and the like, according to a high definition multimedia interface (HDMI), a universal serial bus (USB), a component, and the like, or receive communication data through a communication network.

The communicator 110 may further include not only an element for receiving a signal/data from the external input, but also various additional elements such as a wireless communication module for wireless communication, a tuner to be tuned to a broadcasting station signal, and the like. The communicator 110 may transmit information, data, a signal, and the like, from the calibration device 1 to an external device in addition to receiving a signal from the external device. For example, the communicator 110 is not limited to an element for receiving a signal from the external device, but may be an interface for interactive communication. The communicator 110 may receive a control signal for selecting a user interface (UI) from a plurality of control devices. The communicator 110 may include communication modules for short-range wireless communications such as Bluetooth, Infrared (IR), ultra wideband (UWB), Zigbee, and the like, or may include a communication port for wired communication. The communicator 110 may be used for various purposes of transmitting/receiving a command for display control, data, and the like, as well as a control signal for selecting the UI.

The controller 100 receives the execution command for the calibration with regard to the plurality of display apparatuses, transmits the setup value corresponding to the execution command to the plurality of display apparatuses, transmits a setup value corresponding to the execution command to the image taking device, receives a captured image of the plurality of display apparatuses from the image taking device, and transmits the control command for the calibration to the corresponding the display apparatuses based on the received taken image. For example, the display apparatuses may be displaying an image to be used for calibration when the picture is captured by the image taking device.

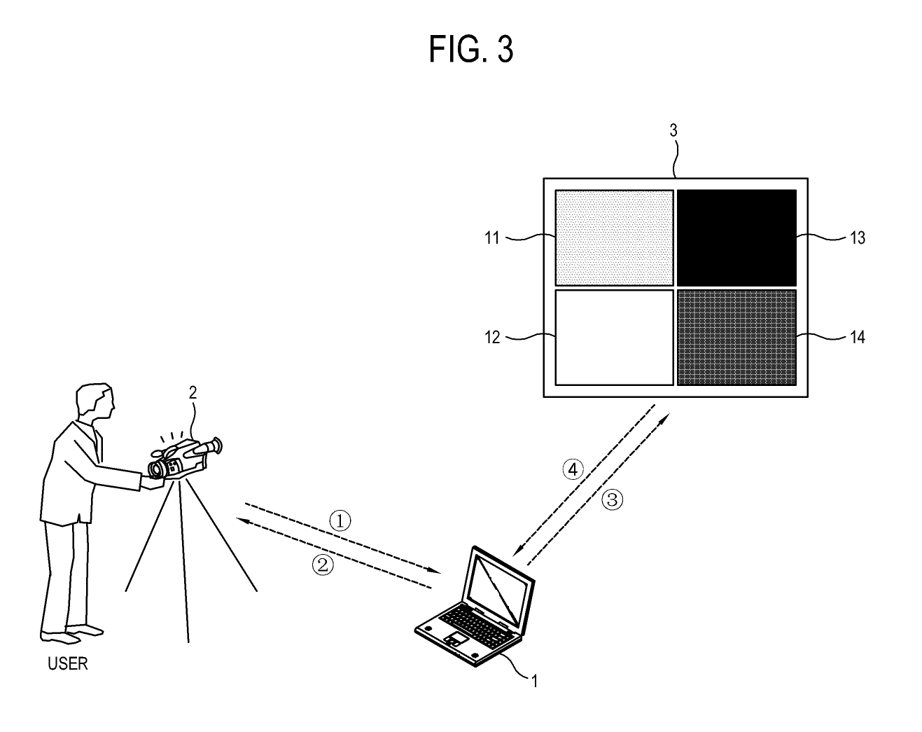

FIG. 2 is a block diagram illustrating the calibration device according to another exemplary embodiment, and FIG. 3 is a diagram illustrating a display apparatus being calibrated. The calibration device 1 in this example further includes the image processor 120, a display 130, a user input 140, a storage 150, and a UI generator 160 in addition to the elements of FIG. 1.

There is no limit to the imaging processes that may be performed in the image processor 120. For example, the imaging process may include de-multiplexing for dividing a predetermined signal into signals according to characteristics, decoding to a format of a predetermined signal, de-interlacing for converting an image signal of an interlace type into a progressive type, noise reduction for improving image quality, detail enhancement, frame refresh rate conversion, and the like. For example, the image processor 120 may include a decoder for decoding a source image corresponding to an image format of an encoded source image, and a frame buffer for storing the decoded source image in units of frames.

The image processor 120 may be a system on chip in which such various functions are integrated, an image processing board in which individual elements for independently performing each process are mounted on a printed circuit board, and the like, and may be embedded in the calibration device 1.

The image processor 120 may perform various imaging processes with regard to a broadcasting signal including an image signal received from a receiver, and a source image including an image signal received from an image source. The image processor 120 outputs such a processed image signal to the display apparatuses 11 to 14 (shown in FIG. 3) and the display 130, so that the processed source image can be displayed on the calibration device 1 and the display apparatuses 11 to 14.

The display 130 may display an image based on the image signal output from the image processor 120. The display 130 may be various display types such as liquid crystal (LCD), plasma display panel (PDP), a light-emitting diode (LED), an organic light-emitting diode (OLED), a surface-conduction electron-emitter, a carbon nano-tube, nano-crystal, and the like, without any limitation.

The display 130 may include an additional element in accordance with types. For example, if the display 130 is a liquid crystal type, the display 130 may include a liquid crystal display panel, a backlight unit for emitting light, and a panel driving substrate for driving the liquid crystal display panel. The display 130 displays an image based on the image signal processed by the image processor 120. The display 130 may include an LCD, a PDP, an OLED, or the like, without limiting the type of displaying an image. Also, the display 130 may include a corresponding LCD panel, a PDP panel, an OLED panel, and the like.

The display 130 may display an image and color calibration. The display 130 may include a display panel to display an image thereon, and a panel driver to process an input image signal to be displayed as an image on the display panel. The image signal received from an external input source through the interface may undergo decoding, deinterlacing, scaling and/or other imaging processes and be displayed on the display 130. When the controller 100 performs the color calibration in accordance with a user's command, the display 130 may display the color calibration procedure including a color patch, a color calibration state window, and the like.

The user input 140 may transmit various preset control commands or information to the controller 100 in accordance with a user's control or input. The user input 140 may include one or more of a menu key or input panel installed on the outside of the display apparatus, a remote controller separated from the display apparatus, and the like. Also, the user input 140 may be integrated with the display 130. For example, if the display 130 is a touch-screen, a user may touch an input menu displayed on the display 130 to transmit the preset command to the controller 100.

The user input 140 may also include elements that receive a user's motion and/or speech. A user's motion may include a touch input. The user input 140 may directly receive a user's motion and speech, or receive information about a user's motion and speech from an external device. For example, the user input 140 may include a device such as a camera and a microphone. Also, the user input may receive a command that includes a combination of speech and motion commands.

The storage 150 may include a nonvolatile memory, for example, a writable read only memory (ROM) so that data can remain even though the calibration device 1 is powered off. The storage 150 may include a flash Memory or one of an erasable and programmable read only memory (EPROM) and an electrically erasable programmable read only memory (EEPROM).

The UI generator 160 may generate a user interface (UI) for operating an executed application program. The generated UI may include a plurality of sub UIs provided in the form of an icon, a text, and the like. If a user selects a certain sub UI through the calibration device 1, an application program may operate corresponding to the selected sub UI. For example, the respective sub UIs may be generated in units of plural functions or events for operating an application program that is being executed by the calibration device 1.

The UI generator 160 refers to a software or hardware function for generating and controlling the UI displayed on the display 130, and has functions that may be performed by the controller 100. In other words, the UI generator 160 may not be a separate chipset or microprocessor. The UI generator 160 may generate a UI of an application for calibrating the plurality of display apparatuses 11 to 14.

As an example, the execution command for calibrating the plurality of display apparatuses 11 to 14 may include an input for selecting either some or all of the plurality of display apparatuses, an input for selecting one among an automatic setup mode, a color temperature setup mode, and a reference apparatus setup mode, and an input for setting up at least one among brightness, color temperature and a reference apparatus with regard to the plurality of display apparatuses.

According to various aspects, the setup value for the display apparatuses 11 to 14 may include a setup value for the displays of the corresponding display apparatuses such as one from among brightness, color temperature, and a reference apparatus of the plurality of display apparatuses 11 to 14. Also, the setup value for the image taking device 2 (shown in FIG. 3) may include a setup value about at least one of white balance and exposure of the image taking device 2 such as one setup from among brightness, color temperature, and a reference apparatus with regard to the plurality of display apparatuses 11 to 14.

The controller 100 may set up an area of the captured image corresponding to the display apparatuses 11 to 14, and calculate a characteristic value about the setup area of the taken image. The controller 100 may set the area by analyzing the taken image and assigning respective areas of the display apparatuses, and analyze and calculate the characteristic value about the image of the assigned area. For example, in response to receiving an execution command for the calibration, the controller 100 may transmit the control command for photographing the plurality of display apparatuses 11 to 14 to the image taking device. For example, the control command may include information for setting up external conditions for photographing the plurality of display apparatuses 11 to 14. Thus, the controller 100 may receive an image from the image taking device 2.

In response to receiving a user's target value, the controller 100 may calculate the setup value for the corresponding display apparatuses 11 to 14 to reach or otherwise achieve the target value. When receiving a user's target value, the controller 100 may control the image taking device 2 to photograph the plurality of display apparatuses 11 to 14 and receive the taken image. Also, the controller 100 may receive setup conditions for displaying an image from the respective display apparatuses 11 to 14. The controller 100 may analyze a characteristic value of the display apparatuses 11 to 14 based on the received taken image, and calculate the setup value for adjusting the setup conditions of the display apparatuses 11 to 14. Accordingly, the controller 100 may transmit the calculated setup value for adjusting setup conditions to the display apparatuses 11 to 14 in the control command.

If one display apparatus from among the plurality of display apparatuses 11 to 14 is selected as a reference apparatus for the calibration, the controller 100 may send the other relevant display apparatuses 11 to 14 the setup value for reaching the characteristic value of the selected reference apparatus. In other words, the plurality of display apparatuses may be calibrated to have the same display characteristic as the reference apparatus. The reference apparatus may be input by a user, or may be automatically set up for the calibration based on a certain condition. The relevant display apparatuses 11 to 14 may perform the calibration using the setup value continuously received from the calibration device 1. Also, the image taking device 2 may continuously receive the control command for photographing the plurality of display apparatuses 11 to 14 received from the calibration device 1, and transmit the taken image to the calibration device 1.

If a message indicating that the calibration is not possible is received from at least one among the plurality of display apparatuses 11 to 14, the controller 100 may change the setup value or reference apparatus 11 to 14 for the calibration. The controller 100 may automatically set up the reference apparatus if the calibration is for a certain condition, or otherwise receive from the display apparatus a message that the calibration is impossible. In this case, the at least one display apparatuses cannot perform the calibration, and therefore the controller 100 may change a value included in the control command for calibration or change the reference apparatus for the calibration, calculate the control command to be transmitted to the corresponding display apparatuses 11 to 14, and transmit the calculated control command to the corresponding display apparatuses 11 to 14.

In FIG. 3, the calibration device 1 is illustrated as a notebook computer that can communicate with a camera 2 and a plurality of display apparatuses 11 to 14.

Referring to FIG. 3, in response to receiving the target value from a user, the calibration device 1 transmits the setup value to the display apparatuses 11 to 14 corresponding to the execution command (\textcircled{3}), and transmits the setup value for the image taking device 2 corresponding to the execution command to the image taking device 2 (\textcircled{2}). Through this procedure, the plurality of display apparatuses 11 to 14 display a setup value corresponding to the target value on a respective screen thereof, and the image taking device 2 sets up an optimum condition for photographing.

The calibration device 1 also transmits a control command for photographing the display system 3 including the plurality of display apparatuses 11 to 14 to the camera 2 (\textcircled{2}), and the camera 2 photographs the plurality of display apparatuses 11 to 14 and transmits the taken image to the calibration device 1 (\textcircled{1}). The calibration device 1 analyzes the received image and sets up areas corresponding to the respective display apparatuses 11 to 14, thereby calculating the characteristic value. Further, a setup value is calculated to make the characteristic value calculated with regard to the setup area of the taken image reach the target value, and it is transmitted to the corresponding display apparatuses 11 to 14 (\textcircled{3}). If one of the display apparatuses 11 to 14 is not capable of performing the calibration, the display apparatuses 11 to 14 transmit a message to the calibration device 1 indicating calibration is not possible (\textcircled{4}). In this example, the calibration device 1 calculates the setup value again and retransmits it to the corresponding display apparatuses 11 to 14 (\textcircled{3}) in another control command. Here, the camera 2 is already adjusted in distance, angle, and the like, by a user.

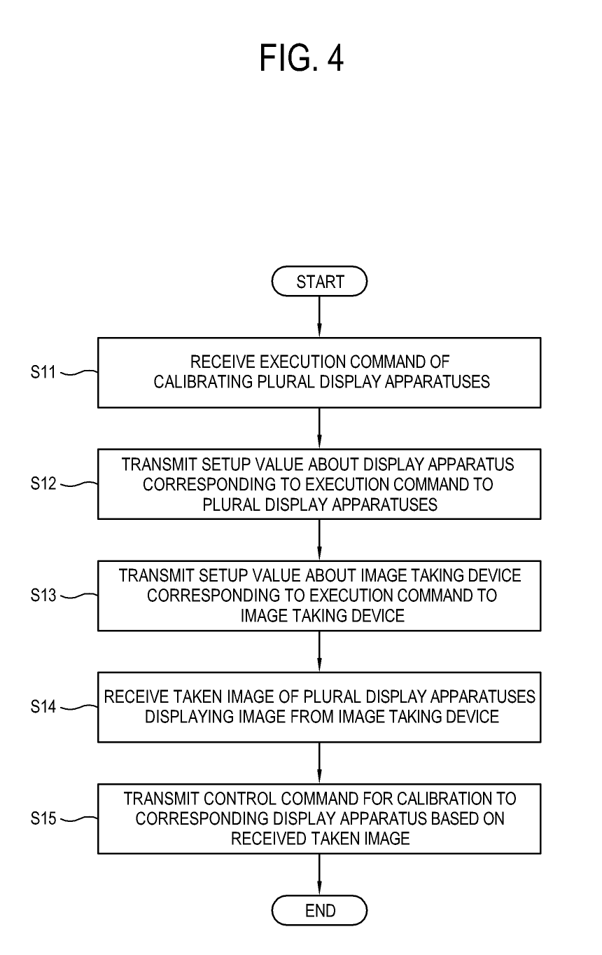

FIG. 4 is a flowchart illustrating a calibration method of the calibration device 1 according to an exemplary embodiment.

The controller 100 receives a command of executing the calibration for the plurality of display apparatuses 11 to 14 (S11).

The controller 100 transmits the setup value about the display apparatuses 11 to 14 corresponding to the execution command, to the plurality of display apparatuses 11 to 14 (S12). Further, the calibration device 1 transmits the setup value for the image taking device 2 corresponding to the execution command, to the image taking device 2 (S13).

The controller 100 receives an image taken of the plurality of display apparatuses 11 to 14 while they are displaying an image, from the image taking device 2 (S14). Further, the controller 100 also transmits a command to the image taking device 2 to photograph the plurality of display apparatuses 11 to 14. Based on the received taken image, the calibration device 1 transmits the control command for calibrating the corresponding display apparatuses 11 to 14 (S15).

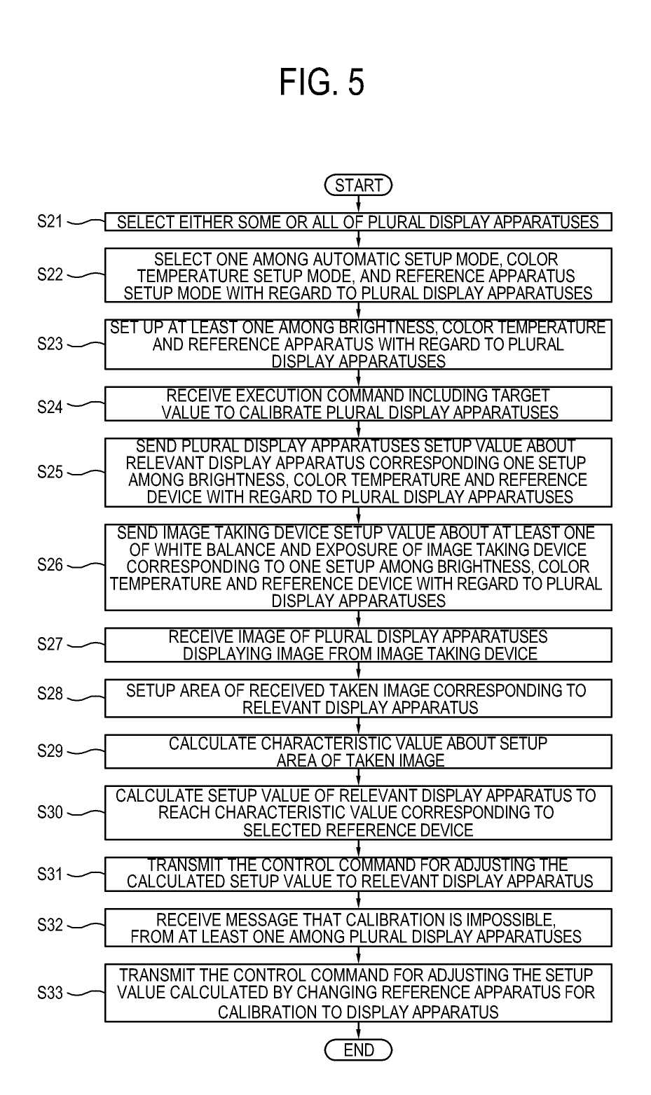

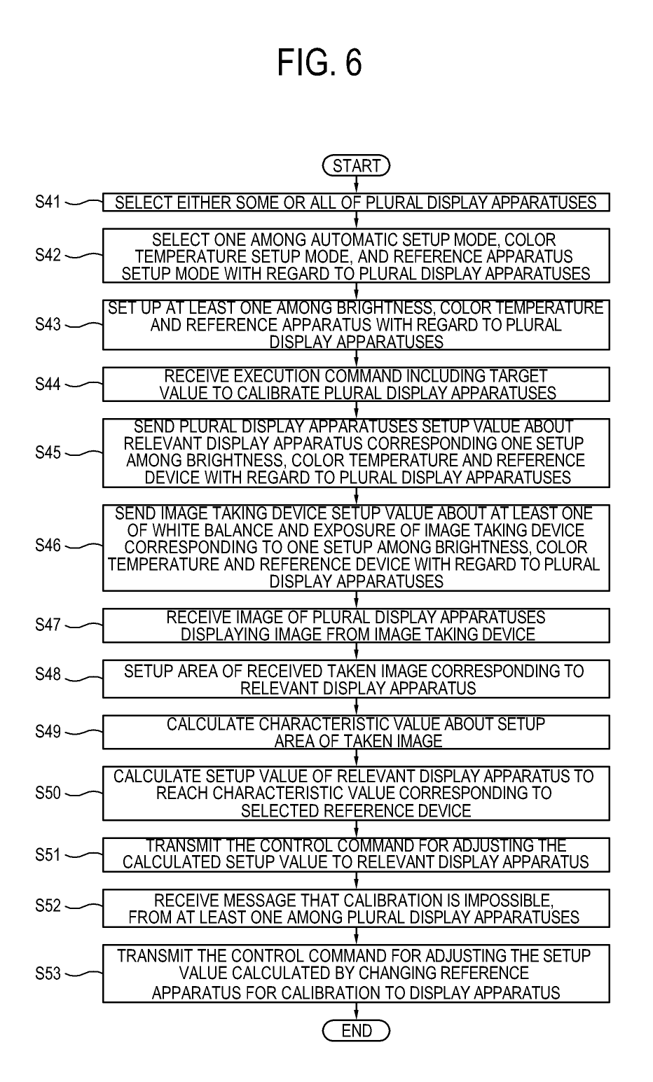

FIGS. 5 and 6 are flowcharts illustrating calibration methods of the calibration device 1 according to other exemplary embodiments.

Referring to FIG. 5, the controller 100 selects either some or all of the plurality of display apparatuses 11 to 14 (S21).

The controller 100 selects one from among an automatic setup mode, a color temperature setup mode, and a reference apparatus setup mode with regard to the plurality of display apparatuses 11 to 14 (S22).

The controller 100 sets up at least one from among the brightness, the color temperature, and the reference apparatus, with regard to the plurality of display apparatuses 11 to 14 (S23).

The controller 100 receives the execution command including the target value for the calibration with regard to the plurality of display apparatuses 11 to 14 (S24).

The controller 100 transmits the setup value corresponding to one of brightness, color temperature and a reference apparatus for the relevant display apparatuses 11 to 14, to the plurality of display apparatuses 11 to 14 (S25).

The controller 100 sends the setup value to the image taking device 2 in (S26). The setup value is about at least one of white balance and exposure of the image taking device 2 corresponding to one setup value from among the brightness, the color temperature, and the reference apparatus, with respect to the plurality of display apparatuses 11 to 14 (S26).

The controller 100 receives the image of the plurality of display apparatuses 11 to 14 that is captured while they are displaying an image, from the image taking device 2 (S27). Further, the calibration device 1 may transmit a command to request the image taking device 2 to photograph the plurality of display apparatuses 11 to 14.

The controller 100 sets up an area of the taken image to correspond to the relevant display apparatus (S28).

The controller 100 analyzes the characteristic value about the setup area of the taken image and calculates the respective characteristic value (S29). For example, the controller 100 may replace the characteristic value by a value analyzed with respect to the area of the taken image.

The controller 100 calculates the setup value of the display apparatuses 11 to 14 to achieve the target value (S30). For example, the controller 100 may request the setup condition and receive it from the plurality of display apparatuses 11 to 14, and may calculate the setup value for the calibration based on the setup condition.

The controller 100 transmits the control command for adjusting the calculated setup value or the setup conditions of the display apparatuses 11 to 14 to the corresponding display apparatuses 11 to 14 (S31).

The controller 100 receives a message indicating that the calibration is impossible (S32). For example, one of the display apparatuses 11 to 14 may have a maximum allowable setup value of “80” to which the brightness may be adjusted even though the setup value of “100” is input for adjusting the brightness. In this example, one or more of the display apparatuses is not able to perform the calibration and therefore transmits the message that the calibration is impossible to the calibration device 1.

The controller 100 changes the target value to calculate a setup value that is allowable, and transmits a control command including the calculated setup value to the corresponding display apparatuses 11 to 14 (S33).

FIG. 5 illustrates an example in which the target value is input, and FIG. 6 illustrates an example in which the input is performed by selecting the reference apparatus 11 to 14. FIG. 6 is a similar flowchart as FIG. 5 if the target value of FIG. 5 is replaced by the characteristic value of the selected reference apparatus 11 to 14, and thus repetitive descriptions thereof are omitted. The operations S41 to S53 of FIG. 6 correspond to S21 to S33 of FIG. 5.

Here, the operations of FIG. 5 are the same as those of FIG. 6, but may be different as to which of the display apparatuses 11 to 14 perform the calibration. In FIG. 5, the calibration is performed with regard to all the plurality of display apparatuses 11 to 14, but in FIG. 6, the calibration is not performed in a reference apparatus from among the display apparatuses 11 to 14.

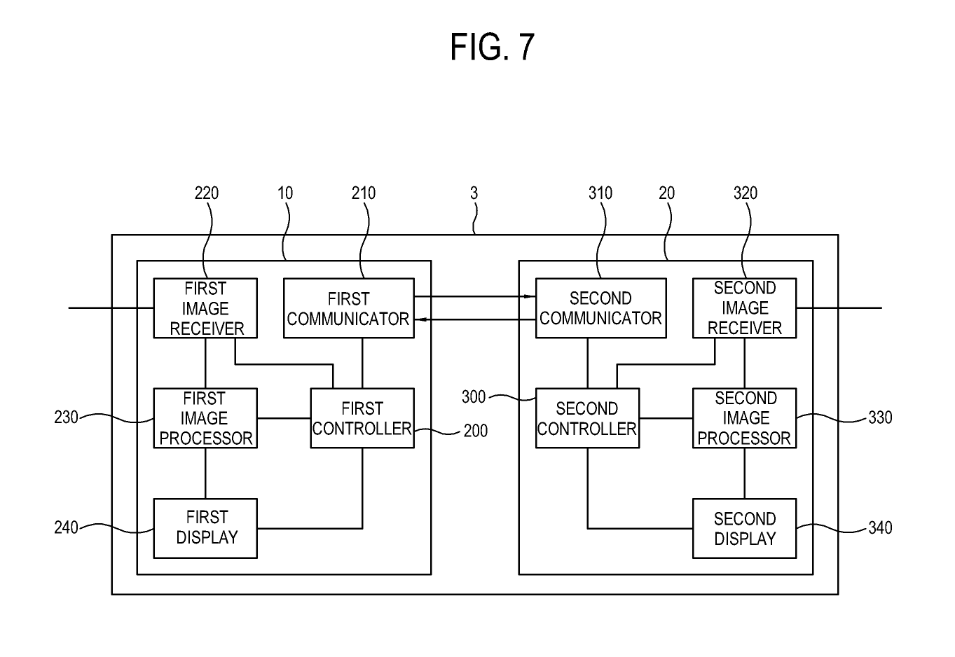

FIG. 7 is a block diagram illustrating a display system 3 according to an exemplary embodiment. In this embodiment, the display system 3 includes a plurality of display apparatuses 10 to 20. The plurality of display apparatuses 10 to 20 include a first display apparatus 10 and a second display apparatus 20.

Referring to FIG. 7, the first display apparatus 10 includes a first communicator 210, a first image receiver 220, a first image processor 230, a first display 240, and a first controller 200. The first communicator 210, the first image processor 230 and the first display 240 may have the same functions as the communicator 110, the image processor 120 and the display 130 of FIG. 2, and thus repetitive descriptions are omitted.

The first image receiver 220 receives an image signal/video data through a wire or wirelessly, and transmits it to the first image processor 230. For example, the first image receiver 220 may receive a TV broadcasting signal, or the like, from a broadcasting signal transmitter, and an image signal from a digital versatile disc (DVD) player, a Blu-ray disc (BD) player, and the like imaging device. As another example, the first image receiver 220 may receive an image signal from a personal computer (PC), a smart phone, a smart pad, or other mobile devices, and an image signal through Internet, or other network, video contents stored in a universal serial bus (USB) storage medium or other storage medium, and the like.

Alternatively, the image signal may not be received through the first image receiver 220, but may be stored and provided from a storage that is not shown. The first image receiver 220 may include various forms according to the formats of the received image signal and types of the display apparatuses 10 to 20. For example, the first image receiver 220 may receive a radio frequency (RF) signal, or an image signal based on composite video, component video, super video, SCART, high definition multimedia interface (HDMI), display port, unified display interface (UDI), wireless HD standards, and the like. The first image receiver 220 may also include a tuner to tune to a broadcasting signal according to channels.

The first controller 200 receives a control command in order to perform the calibration from the second display apparatus 10 and performs the calibration according thereto.

In this example, the second display apparatus 20 includes a second communicator 310, a second image receiver 320, a second image processor 330, a second display 340, and a second controller 300. The second communicator 310, the second image receiver 320, the second image processor 330, and the second display 340 may be the same as the first communicator 210, the first image receiver 220, the first image processor 230 and the first display 240 that are described with respect to the display apparatus 20.

The second controller 300 may receive the image of the display apparatus 10 and the display apparatus 20 while they are displaying images, from the image taking device 2, and perform calibration based on the received the taken image. In response, the second controller 300 transmits the control command for calibration to the display apparatus 10.

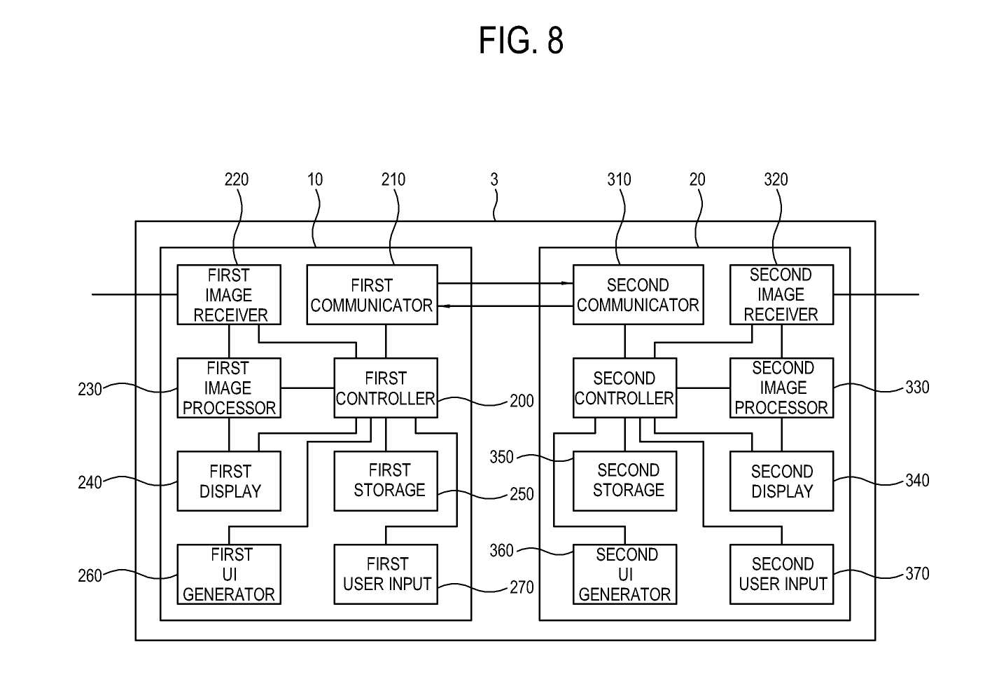

FIG. 8 is a block diagram illustrating a display system 3 according to an exemplary embodiment.

Referring to FIG. 8, the display apparatus 10 includes the elements of the first display apparatus of FIG. 7, and additionally includes a first storage 250, a first UI generator 260, a first user input 270, which may have the same functions as the storage 150, the UI generator 160, and the user input 140 as described with respect to FIG. 2.

The second display apparatus 20 includes the elements of FIG. 7 and additionally includes a second storage 350, a second UI generator 360 and a second user input 370, which may have the same functions as the first storage 250, the first UI generator 260 and the first user input 270 of FIG. 7.

The second controller 300 may set an area of the image captured by the image capturing device received and corresponding to the relevant display apparatuses 10 to 20, and calculate a characteristic value about the setup area of the taken image.

The second controller 300 may calculate the setup value of the relevant display apparatuses in order to reach the target value in response to receiving the target value from a user.

If one from among the plurality of display apparatuses 10 to 20 is selected as the reference apparatus for calibration, for example, display apparatus 20, the second controller 300 may send the relevant display apparatus 10 the control command including information to cause the display apparatus 10 to reach the characteristic value corresponding to the selected reference apparatus 20.

In some examples, the second display apparatus 20 may receive the message indicating that the calibration is impossible from the first display apparatus 10. Accordingly, the second controller 300 may change the control command for the calibration or the reference apparatus.

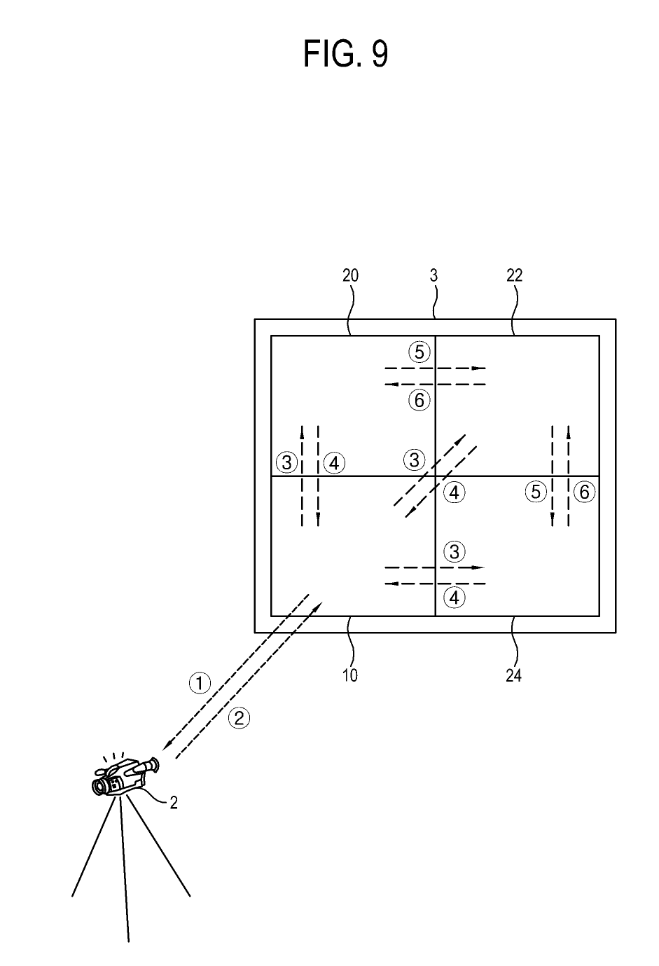

FIG. 9 is a diagram illustrating display apparatuses 10 to 24 that are calibrated by the display system 3 according to an exemplary embodiment.

Referring to FIG. 9, in the display system 3, the display apparatus 10 receives the target value from a user, and the display apparatus 10 transmits the setup value about the other display apparatuses 20 to 24 corresponding to the target value to the other display apparatuses 20, 22, and 24 (\textcircled{3}).

The display apparatus 10 transmits the setup value that is optimized for photographing by the camera 2 (\textcircled{1}).

The display apparatus 10 transmits the control command for photographing the display system 3 to the camera 2 (\textcircled{1}), and the camera 2 photographs the display apparatuses 20 to 24 and the display apparatus 10 and transmits the captured photograph image to the display apparatus 10 (\textcircled{2}).

The display apparatus 10 analyzes the received image and sets up an area corresponding to three display apparatuses 20 to 24 and calculates the characteristic value. In this example, the display apparatus 10 calculates the setup value for making the characteristic value calculated with regard to the setup area of the taken image reach the target value, and transmits it to the three other display apparatuses 20 to 24 (\textcircled{3}).

Here, the display apparatus 10 may transmit the calculated setup value to the display apparatuses 20 to 24 in different routes. For example, the display apparatus 10 may transmit the calculated setup value to one of the display apparatuses 20 to 24 (\textcircled{3}). For example, the display apparatuses 20 may receive the setup value of the corresponding display apparatuses 22 to 24, and may transmit the calculated setup value to one or more of the neighboring display apparatuses 22 to 24 (\textcircled{5}). The other display apparatus 22 or 24 may receive the setup value of the corresponding display apparatus 22 or 24, and may transmit the calculated setup value to another display apparatuses. Thus, the display apparatus 20 to 24 may perform the calibration by receiving the setup value for the calibration from neighboring display apparatuses.

As another example, if the setup value is not for calibration, the display apparatuses 20 to 24 may transmit a message indicating this to the display apparatus 10 through a route that is opposite to routes (\textcircled{4} or \textcircled{6}). The display apparatus 10 may calculate the setup value again and retransmit it to the display apparatuses 20 to 24 (\textcircled{3}, \textcircled{5}). Thus, the display apparatuses 20 to 24 may receive the setup value for calibration again and perform the calibration.

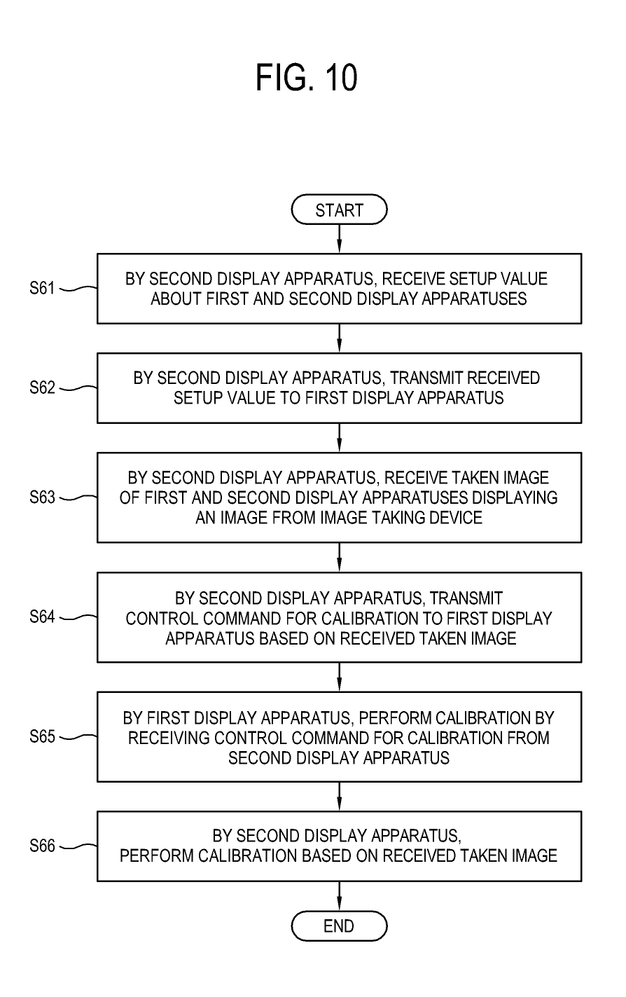

FIG. 10 is a flowchart illustrating a calibration method of a display system 3 according to an exemplary embodiment.

The display apparatus 10 receives the setup value about the display apparatuses 20 to 24 and the display apparatus 10 (S61).

In response, the second display apparatus 10 transmits the received setup value of the first display apparatuses 20 to 24 to the respective first display apparatuses 20 to 24 (S62).

The display apparatus 10 receives the image that is captured of the display apparatuses 20 to 24 and the display apparatus 10 while they are displaying images, from the image taking device 2 (S63).

The display apparatus 10 transmits the control command for calibration to the display apparatuses 20 to 24 based on the received captured image (S64).

The display apparatuses 20 to 24 perform the calibration in response to receiving the control command for calibration from the display apparatus 10 (S65).

The display apparatus 10 performs the calibration based on the received taken image (S66).

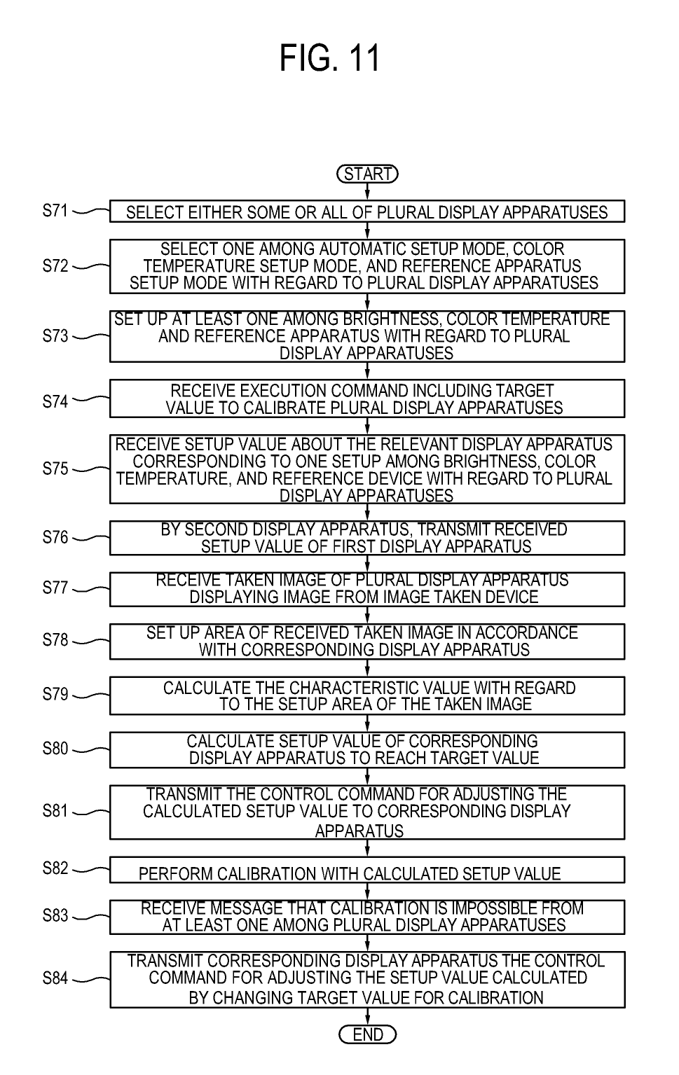

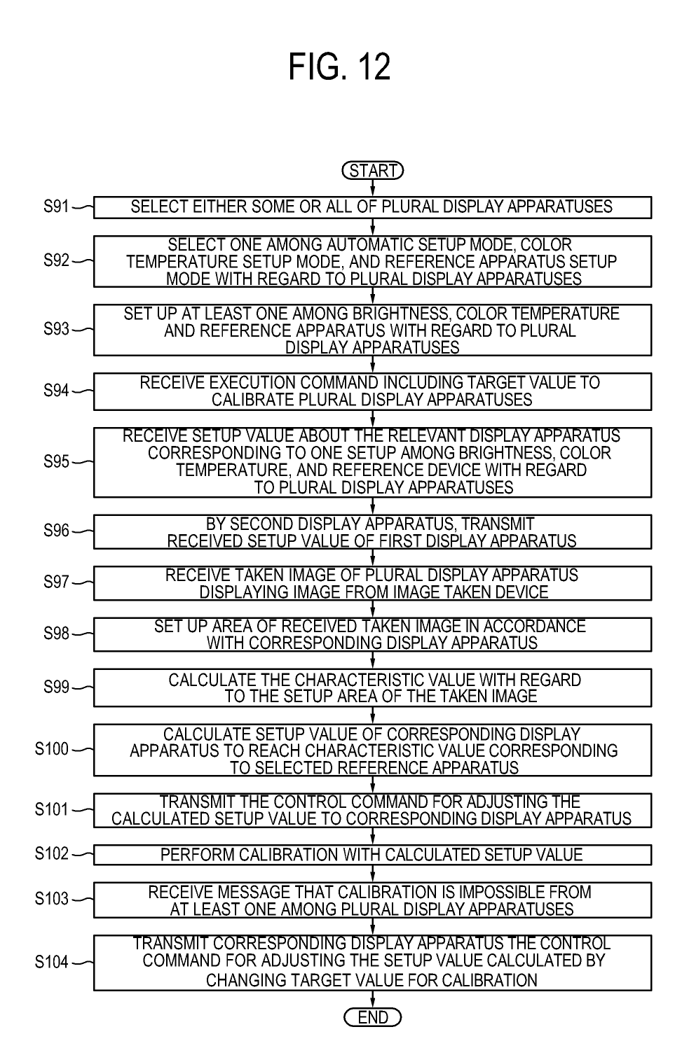

FIGS. 11 and 12 are flowcharts illustrating calibration methods of the display system 3 according to exemplary embodiments.

Either some or all of the plurality of display apparatuses 10 to 24 may be selected (S71).

With regard to the plurality of display apparatuses 10 to 24, a mode from among the automatic setup mode, the color temperature setup mode, and the reference apparatus setup mode is selected (S72).

With regard to the plurality of display apparatuses 10 to 24, one from among the brightness, the color temperature, and the reference apparatus is set up (S73).

The execution command including the target value for calibrating the plurality of display apparatuses 10 to 24 is received (S74).

The setup value about the display apparatuses 10 to 24 that are to be calibrated is received corresponding to the setup for one among the brightness, the color temperature, and the reference apparatus (S75).

In this example, the display apparatus 10 transmits the received setup value of the display apparatuses 10 to 24 (S76).

The display apparatus 10 receives the image that is captured of the plurality of display apparatuses 10 to 24 while they are displaying an image, from the image taking device 2 (S77). The display apparatus 10 transmits a command to the image taking device 3 to photograph an image of the plurality of display apparatuses 10 to 24.

Further, the display apparatus 10 sets up the area of the received image in accordance with the relevant display apparatuses 10 to 24 (S78).

The display apparatus 10 analyzes the characteristic value by analyzing the characteristic value about the setup area of the image, and calculates the characteristic value (S79) based on the analyzing. For example, the display apparatus 10 may replace the characteristic value by the value analyzed with regard to the area of the received image.

The display apparatus 10 calculates the setup value of the relevant display apparatuses 10 to 24 in order to reach the target value (S80). For example, the display apparatus 10 may request and receive the setup conditions from the plurality of display apparatuses 10 to 24, and calculate the setup value for calibration based on the setup conditions.

The display apparatus 10 sends, to the corresponding other display apparatuses 20 to 24, the control command for adjusting the characteristic value or the setup conditions of the display apparatuses 20 to 24 (S81).

The display apparatus 10 performs the calibration based on the calculated setup value (S82).

The display apparatus 10 receives, from one or more of the display apparatuses 20 to 24, the message that the calibration is impossible (S83). For example, if one or more of the corresponding display apparatuses 20 to 24 have a maximum allowable setup value of “8,000” with which to adjust a color temperature although the setup value of “10,000” is input for adjusting the color temperature, the corresponding display apparatuses 20 to 24 are not able to perform the calibration. Accordingly, the corresponding display apparatus may transmit the message that the calibration is impossible to the display apparatus 10.

The display apparatus 10 changes the target value for the calibration and calculates an allowable setup value, and retransmits the calculated setup value to the display apparatuses 20 to 24 (S84). Thus, the display apparatuses 20 to 24 can perform the calibration.

FIG. 12 is a flowchart illustrating a calibration method of the display system 3 according to an exemplary embodiment.

FIG. 12 shows a flowchart similar to FIG. 11, but in this example the target value of FIG. 11 is replaced by the characteristic value of the reference apparatus 10 to 24. In FIG. 12, operations S91 to S104 correspond to the operations S71 to S84 of FIG. 11. FIGS. 11 and 12 show substantially the same control flowcharts, and thus repetitive descriptions thereof is omitted.

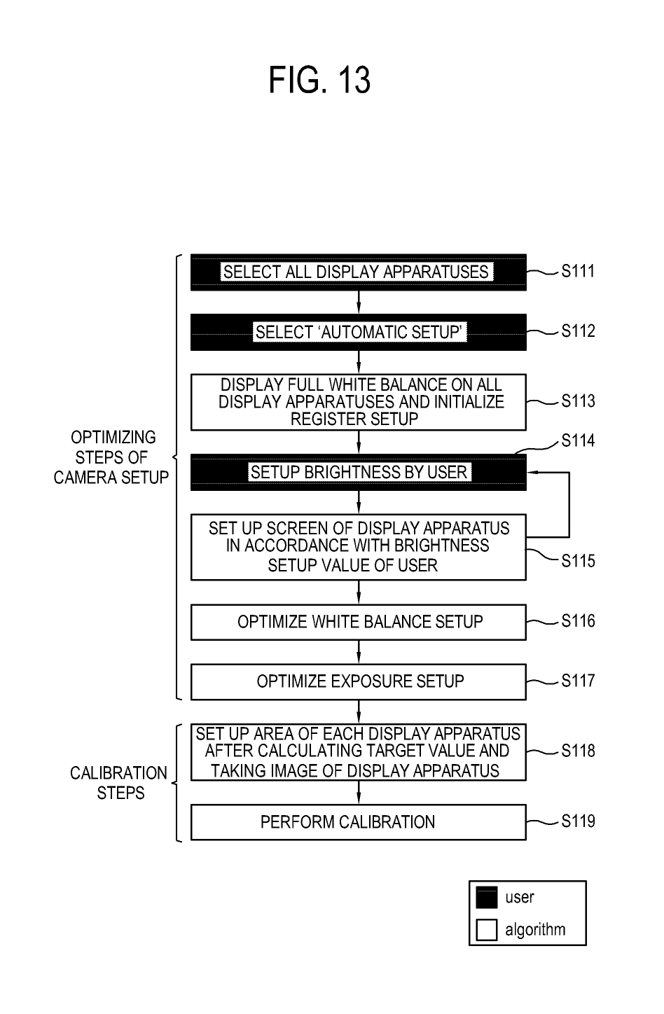

FIGS. 13 to 15 are flowcharts illustrating calibration methods of the display system according to exemplary embodiments.

Referring to FIGS. 13 to 15, a user selects all of the plurality of display apparatuses 10 to 24 (S111). A user sets up the automatic setup mode for the plurality of display apparatuses 10 to 24 (S112). The display apparatus 10 displays the white balance of the display apparatuses 10 to 24 and initializes setup (S113). A user sets up the execution command for the brightness (S114).

The display apparatus 10 sends the corresponding display apparatuses 10 to 24 the setup value for the screen of the display apparatuses 10 to 24 corresponding to a user's target value for the brightness (S115). The display apparatus 10 transmits the setup value for setting up the white balance to the camera 2 (S116). The display apparatus 10 transmits the setup value for the exposure to the camera 2 (S117).

The display apparatus 10 receives the image of the plurality of display apparatuses 10 to 24 taken while they are displaying an image, from the image taking device 2. The display apparatus 10 transmits a photographing command to the image taking device 2 so that an image of the plurality of display apparatuses 10 to 24 can be taken and transmitted. Further, the display apparatus 10 sets up the area of the taken image in accordance with the corresponding display apparatuses 10 to 24 (S118).

The display apparatus 10 calculates the characteristic value by analyzing the characteristic value with regard to the setup area of the taken image. For example, the display apparatus 10 may replace the characteristic value with the value analyzed with regard to the area of the taken image. The display apparatus 10 calculates the setup value of the corresponding display apparatuses 10 to 24 to reach the target value. For example, the display apparatus 10 may request and receive the setup conditions from the plurality of display apparatuses 10 to 24, and calculate the setup value for the calculation through the setup conditions. The display apparatus 10 sends the corresponding display apparatuses 20 to 24 the control command for adjusting the calculated setup value or the setup conditions of the display apparatuses 20 to 24. The display apparatus 10 performs the calibration with the calculated setup value. For example, the display apparatus 10 may receive from the other display apparatuses 20 to 24 the message that the calibration is impossible. Accordingly, the display apparatus 10 calculates the setup value by changing the target value for the calibration, and retransmits the changed setup value to the corresponding display apparatuses 20 to 24. Thus, the display apparatuses 20 to 24 can perform the calibration (S119).

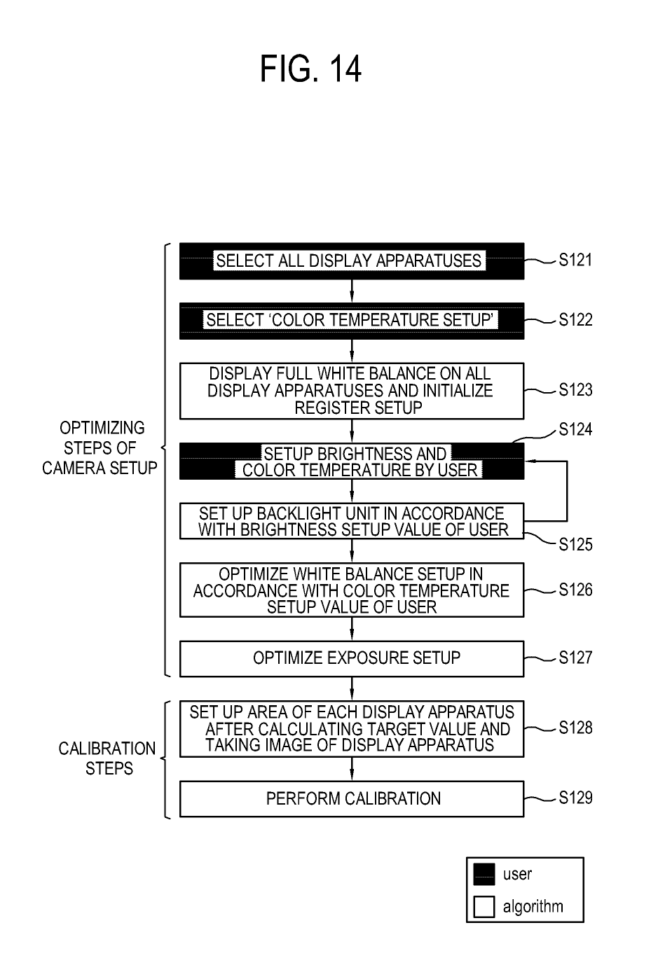

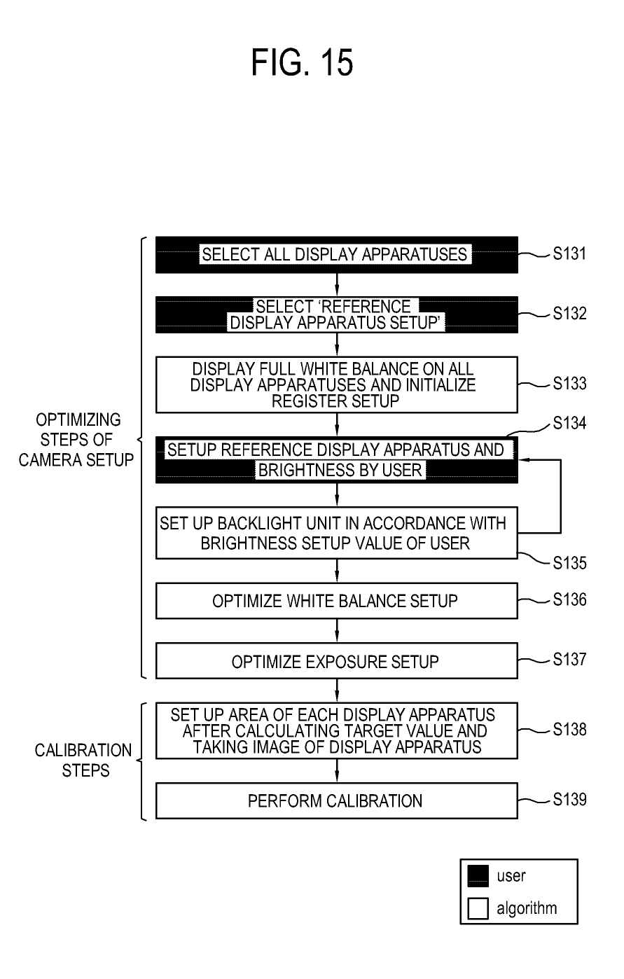

The foregoing flowcharts are also involved in FIGS. 13 through 15. However, FIG. 13 illustrates an example of performing the calibration based on the automatic setup and the brightness setup. FIG. 14 illustrates an example of setting up color temperature, and performing the calibration based on the brightness and color temperature setup. In addition, FIG. 15 illustrates an example of setting up the reference apparatus, and performing the calibration based on the reference apparatus and brightness setup. In this example, the automatic setup mode of the operation S112 in FIG. 13 may be replaced by the color temperature setup mode of S122 in FIG. 14, and the reference display apparatus setup mode of S132 in FIG. 15. Further, the setup of the brightness in operation S114 of FIG. 13 may be replaced by the setup of the brightness and the color temperature of S124 in FIG. 14, and the reference apparatus and the brightness of S134 in FIG. 15.

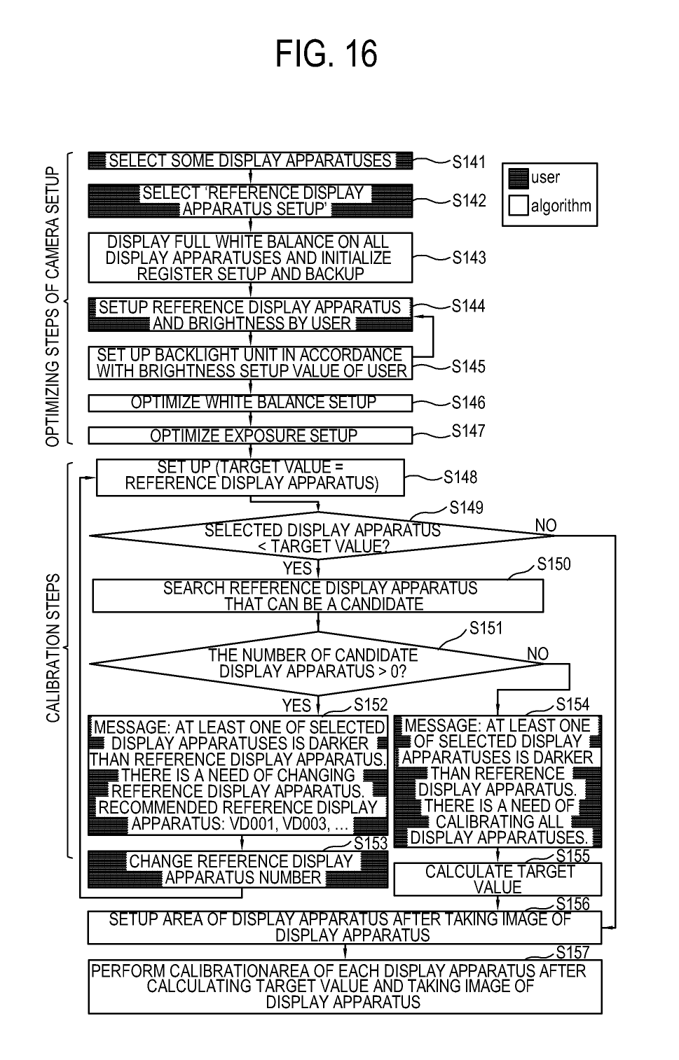

FIG. 16 is a flowchart illustrating a calibration method of the display system according to an exemplary embodiment.

Referring to FIG. 16, a user selects some from among the plurality of display apparatuses 10 to 24 (S141). A user selects the reference apparatus for setup from among the plurality of display apparatuses 10 to 24 (S142). The selected display apparatus 10 displays a white balance pattern of all the display apparatuses 10 to 24 and initializes the register setup (S143). A user sets up the execution command for the reference apparatus and the brightness (S144).

The display apparatus 10 sends the corresponding display apparatuses 20 to 24 the screen setup value of all the display apparatuses 10 to 24 in accordance with a user's brightness target value (S145). The display apparatus 10 also sends the camera 2 the setup value about the white balance setup (S146). The display apparatus 10 sends the camera 2 the setup value about the exposure setup (S147). The display apparatus 10 sets up the setup value of the reference apparatus as the target value (S148).

The display apparatus 10 determines whether the selected setup value of the display apparatuses 10 to 24 is smaller than the target value (S149). For example, if the selected setup value of the display apparatuses 10 to 24, i.e., the brightness has the maximum allowable value of “120”, and there are different display apparatuses 10 to 24 that have a target value of “100” with regard to the brightness of the different display apparatuses 10 to 24, it might be impossible to set up the brightness value for all of the display apparatuses 10 to 24 as the target value.

Therefore, if the selected setup value of one or more of the display apparatuses 10 to 24 is smaller than the target value, another display apparatus is selected as candidate (S150).

Further, the display apparatus 10 determines whether there is another reference display apparatus (S151).

If there is another reference display apparatus that can be a candidate, the display apparatus 10 may show a user another reference display apparatuses and a message that there is a need for changing the reference display apparatus (S152).

Thus, a user changes the reference display apparatus (S153) and returns to the operation S148.

If there is no other reference display apparatuses that can be a candidate in the operation S151, a message that some but not all of the display apparatuses are selected and undergo the calibration (S154). This shows that at least one among the selected display apparatuses is darker than the reference display apparatus.

Therefore, the target value is calculated in regard to the darkest display apparatus as the reference apparatus (S156). In this case, the darkest display apparatus may not be too dark. For example, if the darkest display apparatus has a brightness that is higher than a predetermined level, it may be set as the reference apparatus. On the other hand, if the darkest display apparatus has a brightness that is less than the predetermined level, the display of the darkest display apparatus may be replaced.

The display apparatus 10 receives the image from the image taking device which includes the plurality of display apparatuses 10 to 24 displaying an image. The display apparatus 10 transmits a photographing command to the image taking device 2 so that the image of the plurality of display apparatuses 10 to 24 can be taken and transmitted. Further, the display apparatus 10 sets up the area of the received taken image in accordance with the corresponding display apparatuses 10 to 24. The display apparatus 10 may calculate the characteristic value by analyzing the characteristic value about the setup area of the taken image. Here, the display apparatus 10 may replace the characteristic value by the value analyzed with regard to the area of the taken image.

The display apparatus 10 calculates the setup value of the corresponding display apparatuses 10 to 24 to reach the target value. For example, the display apparatus 10 may request and receive the setup conditions from the plurality of display apparatuses 10 to 24, and calculate the setup value for the calibration through the setup conditions. The display apparatus 10 sends the other display apparatuses 20 to 24 the control command for adjusting the calculated setup value or the setup conditions of the display apparatuses 20 to 24. The display apparatus 10 performs the calibration with the calculated setup value. The display apparatus 10 may receive from the other display apparatuses 20 to 24 the message that the calibration is impossible. For example, if one or more of the display apparatuses 20 to 24 have a maximum allowable setup value of “8000” with regard to the color temperature even though the setup value of “10,000” is input to adjust the color temperature, the one or more display apparatuses 20 to 24 may not be able to perform the calibration and thus transmit the message that the calibration is impossible. In response, the display apparatus 10 may recalculate the setup value by changing the target value the calibration, and retransmit the calculated setup value to the display apparatuses 20 to 24. Thus the display apparatuses 20 to 24 can perform the calibration (S157).

According to various aspects, the calibration device 1, the display system 3, and the image taking device 2 may be used to perform calibration by calculating a setup value for calibrating a plurality of display apparatuses 10 to 24, thereby reducing time and costs that it takes to calibrate the plurality of display apparatuses 10 to 24 and improving accuracy of the calibration. Accordingly, it is possible to reduce time and costs that are taken in calibrating the plurality of display apparatuses and further improve an accuracy of the calibration.

The methods described above can be written as a computer program, a piece of code, an instruction, or some combination thereof, for independently or collectively instructing or configuring a processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

Although a few exemplary embodiments have been shown and described, it will be appreciated by those skilled in the art that changes may be made in these exemplary embodiments without departing from the principles and spirit thereof. The foregoing should be considered as illustrative only. The scope of the disclosure is defined in the appended claims and their equivalents. Accordingly, all suitable modification and equivalents may fall within the scope of the present description.

1. A calibration device comprising:
a communicator configured to communicate with at least one display apparatus from among a plurality of display apparatuses of a display system; and
a controller configured to control the communicator to transmit a setup value for the display apparatuses to the at least one display apparatus, and transmit, to the at least one display apparatus, a control command for calibrating the plurality of display apparatuses based on an image of the plurality of display apparatuses displaying an image, received from the an image taking device.

2. The calibration device of claim 1, wherein the controller is configured to, in response to receiving an execution command to calibrate the plurality of display apparatuses, control the communicator to transmit the setup value for the plurality of display apparatuses to the at least one display apparatus and transmit the setup value for the image taking device to the image taking device.

3. The calibration device according to claim 1, wherein the controller is configured to set up an area of the received image based on the plurality of display apparatuses, and calculate a characteristic value of the set up area of the image.

4. The calibration device according to claim 1, further comprising a user input configured to receive a user command,
wherein the controller is configured to determine the control command to cause the one or more display apparatuses to reach a target value, in response to receiving the target value via the user input.

5. The calibration device according to claim 1, wherein the controller is configured to select a reference apparatus for calibration from among the plurality of display apparatuses, and control the communicator to transmit the control command to cause remaining display apparatuses from among the plurality of display apparatuses to reach a characteristic value of the selected reference apparatus.

6. The calibration device according to claim 1, wherein the controller is configured to, in response to the communicator receiving a message that the calibration is impossible from a display apparatus from among the plurality of display apparatuses, change at least one of a value of the control command and a reference apparatus for the calibration.

7. The calibration device according to claim 2, wherein the execution command comprises:
an input for selecting at least one of the plurality of display apparatuses;
an input for selecting at least one from among an automatic setup mode, a color temperature setup mode, and a reference apparatus setup mode; and
an input for setting up brightness, color temperature, and a reference apparatus with regard to the plurality of display apparatuses.

8. The calibration device according to claim 2, wherein the setup value for the plurality of display apparatuses comprises information about at least one of a brightness, a color temperature, and a reference apparatus with regard to the plurality of display apparatuses.

9. The calibration device according to claim 2, wherein the setup value for the image taking device comprises information about at least one of a white balance and an exposure of the image taking device and corresponds to at least one of a brightness, a color temperature, and a reference apparatus with regard to the plurality of display apparatuses.

10. A method of calibrating a plurality of display apparatuses, the method comprising:
transmitting a setup value for a plurality of display apparatuses to at least one display apparatus from among the plurality of display apparatuses;
transmitting a setup value for an image taking device to the image taking device;
receiving an image of the plurality of display apparatuses displaying an image, from the image taking device; and
transmitting, to the at least one display apparatus, a control command for calibrating the plurality of display apparatuses based on the received image.

11. The method of claim 10, further comprising receiving an execution command for calibrating the plurality of display apparatuses,
wherein the setup value for the plurality of display apparatuses is transmitted to the at least one display apparatus and the setup value for the image taking device is transmitted to the image taking device, in response to the receiving the execution command.

12. The method according to claim 10, wherein the receiving the image comprises:
setting up an area of the image based on the plurality of display apparatuses; and
calculating a characteristic value of the set up area of the image.

13. The method according to claim 10, wherein the transmitting the control command comprises determining the control command to cause the one or more display apparatuses to reach a target value, in response to receiving the target value from a user.

14. The method according to claim 10, further comprising selecting one display apparatus from among the plurality of display apparatuses as a reference apparatus for calibration, and the transmitting comprises transmitting the control command to cause the remaining display apparatuses from among the plurality of display apparatuses to reach a characteristic value of the selected reference apparatus.

15. The method according to claim 10, wherein the transmitting the control command comprises, in response to receiving a message that the calibration is impossible from a display apparatus from among the plurality of display apparatuses, changing at least one of a value of the control command and a reference apparatus for the calibration.

16. The method according to claim 11, wherein the execution command comprises:
an input for selecting either some or all of the plurality of display apparatuses;
an input for selecting at least one from among an automatic setup mode, a color temperature setup mode, and a reference apparatus setup mode; and
an input for setting up brightness, color temperature, and a reference apparatus with regard to the plurality of display apparatuses.

17. The method according to claim 11, wherein the setup value for the plurality of display apparatuses comprises information about at least one of a brightness, a color temperature, and a reference apparatus with regard to the plurality of display apparatuses.

18. The method according to claim 11, wherein the setup value for the image taking device corresponds to at least one of a white balance and an exposure of the image taking device, and corresponds to at least one of brightness, color temperature, and a reference apparatus with regard to the plurality of display apparatuses.

19. A display system comprising a plurality of display apparatuses including a first display apparatus and a second display apparatus,
the first display apparatus comprising: a first communicator configured to communicate with the second display apparatus; a first image receiver configured to receive an image; a first image processor configured to process the received image; a first display configured to display the processed image; and a first controller configured to receive a control command for calibration from the second display apparatus and perform the calibration, and
the second display apparatus comprising: a second communicator configured to communicate with the first display apparatus; a second image receiver configured to receive the image; a second image processor configured to process the received image; a second display configured to display the processed image; and a second controller configured to receive a setup value for the first display apparatus and the second display apparatus, transmit the received setup value to the first display apparatus, transmit a setup value for an image taking device corresponding to the setup value for the first display apparatus and the second display apparatus to an image taking device, receive an image of the first and second display apparatuses displaying images, from the image taking device, perform the calibration based on the received image, and transmit a control command for the calibration to the first display apparatus.

20. The display system according to claim 19, wherein the second controller is configured to set up an area of the received image in accordance with the first display apparatus, and calculate a characteristic value of a setup area of the image.

21. The display system according to claim 19 wherein the second display apparatus further comprises a user input configured to receive a user's command, and
the second controller is configured to determine the control command to cause the first display apparatus to reach a target value, in response to receiving the target value from a user.

22. The display system according to claim 19, wherein, in response to the second display apparatuses being selected as a reference apparatus for calibration, the second controller is configured to transmit a control command to the first display apparatus to cause the first display apparatus to reach a characteristic value of the second display apparatus.

23. The display system according to claim 19, wherein, in response to receiving a message indicating that the calibration is impossible from the first display apparatus, the second controller is configured to change at least one of a value of the control command for the first display apparatus and a reference apparatus for the calibration.

24. The display system according to claim 19, wherein the setup value for the first and second display apparatuses comprises:
an input for selecting either some or all of the plurality of display apparatuses;
an input for selecting at least one from among an automatic setup mode, a color temperature setup mode, and a reference apparatus setup mode; and
an input for setting up a brightness, a color temperature, and a reference apparatus with regard to the plurality of display apparatuses.

25. The display system according to claim 19, wherein the setup value for the plurality of display apparatuses corresponds to at least one of a brightness, a color temperature, and a reference apparatus with regard to the plurality of display apparatuses.

26. The display system according to claim 19, wherein the setup value for the image taking device corresponds to at least one of a white balance and an exposure of the image taking device, and corresponds to at least one of a brightness, a color temperature, and a reference apparatus with regard to the plurality of display apparatuses.

27. A method of calibrating a plurality of display apparatuses including a first display apparatus and a second display apparatus, the method comprising:
receiving, by the second display apparatus, a setup value for the first display apparatus and the second display apparatus;
transmitting, by the second display apparatus, the received setup value to the first display apparatus;
transmitting, by the second display apparatus, a setup value for an image taking device corresponding to the setup value for the first display apparatus and the second display apparatus, to the image taking device;
receiving, by the second display apparatus, an image captured of the first and second display apparatuses displaying images, from the image taking device;
transmitting, by the second display apparatus, a control command for calibration to the first display apparatus based on the received image;
receiving, by the first display apparatus, a control command for calibration from the second display apparatus to perform the calibration; and
performing, by the second display apparatus, the calibration based on the received image.

28. The method according to claim 27, wherein the receiving of the image comprises:
setting up an area of the received image in accordance with the first display apparatus; and
calculating a characteristic value of a setup area of the image.

29. The method according to claim 27, wherein the transmitting of the control command to the first display apparatus comprises calculating the control command for the first display apparatus to reach a target value, in response to receiving the target value from a user.

30. The method according to claim 27, wherein the transmitting of the control command to the first display apparatus comprises, in response to the second display apparatus being selected as a reference apparatus for calibration, transmitting a control command to cause the first display apparatus to reach a characteristic value of the second display apparatus.

31. The method according to claim 27, wherein the transmitting of the setup value to the first display apparatus comprises, in response to receiving a message indicating that the calibration is impossible from the first display apparatuses, changing at least one of a value of the control command and a reference apparatus for the calibration.

32. The method according to claim 27, wherein the setup value for the first and second display apparatuses comprises:
an input for selecting either some or all of the plurality of display apparatuses;
an input for selecting at least one among an automatic setup mode, a color temperature setup mode, and a reference apparatus setup mode; and
an input for setting up a brightness, a color temperature, and a reference apparatus with regard to the plurality of display apparatuses.

33. The method according to claim 27, wherein the setup value for the first and second display apparatuses corresponds to at least one of a brightness, a color temperature, and a reference apparatus with regard to the plurality of display apparatuses.

34. The method according to claim 27, wherein the setup value for the image taking device corresponds to at least one of a white balance and an exposure of the image taking device, and corresponds to at least one of a brightness, a color temperature, and a reference apparatus with regard to the plurality of display apparatuses.
